(19) United States
(12) Patent Application Publication
(10) Pub. No.: US 2014/0279504 A1
(43) Pub. Date: Sep. 18, 2014

(54) SYSTEM AND METHOD FOR GENERATING A SINGLE-USE TIME-LIMITED PURCHASE CODE FOR COMPLETING TRANSACTIONS WITH A PORTABLE COMPUTING DEVICE

(71) Applicants: VICTOR COOK, Wellington, FL (US); Taryn Hartnett, Wellington, FL (US)

(72) Inventors: VICTOR COOK, Wellington, FL (US); Taryn Hartnett, Wellington, FL (US)

(21) Appl. No.: 13/802,749

(22) Filed: Mar. 14, 2013

(51) Int. Cl. G06Q 20/38

(52) U.S. Cl. CPC G06Q 20/385
USPC 705/44

(57) ABSTRACT

A request for a purchase code may be received from a portable computing device (PCD) from a communications network. The request may further include a purchase amount and location information of the PCD. The system determines if a funding account has sufficient funds to cover the purchase amount. If the funding account has sufficient funds to cover the purchase amount, then the system generates a single-use time limited purchase code to the PCD. The system may receive the purchase code from a POS terminal and then it may determine if the received purchase code matches purchase code issued to the PCD. The system may compare the location of the PCD against the POS terminal. If a requested transaction amount is less than or equal to the purchase amount and if the purchase codes and location information match, then they system may generate a message approving the transaction.

### BACKGROUND

Portable computing devices (“PCDs”), such as mobile phones and tablet personal computers (“PCs”), are being used to complete transactions at point-of-sale (“POS”) terminals. Conventional systems which support such PCD transactions usually require a mobile wallet system in which credit cards and bank account information are stored on the PCD. Such conventional systems utilizing mobile wallet systems are often complex and add significant time to complete routine transactions such as grocery purchases and fuel purchases when comparing these purchases to purchases made with traditional credit cards and cash. The conventional mobile wallet systems usually need highly sophisticated security features in order to prevent fraud and to prevent access to sensitive financial account information stored on the PCD.

Further, such conventional systems utilizing mobile wallet systems often require new hardware and software from the merchant in order to support such transactions. What is needed in the art is a system which is simple to use and which does not require significant hardware and software upgrades for the merchant to support payments with a PCD.

### SUMMARY OF THE DISCLOSURE

A method and system for completing a transaction with a portable computing device (“PCD”) includes receiving a request for a purchase code from a communications network. The request may further include a purchase amount and geographical information that identifies a location of the portable computing device. The system determines if a funding account has sufficient funds to cover the purchase amount. If the funding account has sufficient funds to cover the purchase amount, then the system generates a single-use time limited purchase code to the PCD for completing the transaction.

The purchase code may comprise alphanumeric text and it may have a length between about two characters and about sixteen characters. The system may receive the purchase code from a point-of-sale (“POS”) terminal and then it may determine if the received purchase code matches purchase code issued to the PCD. As a further security feature, the system may compare the geographical location of the PCD against the POS terminal. If a requested transaction amount from the POS terminal is less than or equal to the purchase amount and if the purchase codes and geographical information match, then they system may generate a message approving the transaction.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

In the drawings, like reference numerals refer to like parts throughout the various views unless otherwise indicated. For reference numerals with letter character designations such as “102A” or “102B”, the letter character designations may differentiate two like parts or elements present in the same figure. Letter character designations for reference numerals may be omitted when it is intended that a reference numeral to encompass all parts having the same reference numeral in all figures.

FIG. 1A is a functional block diagram illustrating an exemplary system for generating a time-limited purchase code for transactions using a PCD;

FIG. 1B is an exemplary screen display that list options for a PCD which uses a time-limited purchase code for transactions;

FIG. 1C is an exemplary screen display that list options for account management with a PCD which uses a time-limited purchase code for transactions;

FIG. 1D is an exemplary screen display that allows an operator of a PCD to enter a purchase amount prior to requesting a time-limited purchase code for a trans action;

FIG. 1E is an exemplary screen display that conveys a time-limited purchase code for a transaction;

FIG. 1F is an exemplary screen display that allows an operator to select specific sub-account holders for restricting use of an account that is enabled to use time-limited purchase codes for transactions;

FIG. 1G is an exemplary screen display that allows an operator to define specific restrictions for a sub-account holder corresponding to an account that is enabled to use time-limited purchase codes for transactions;

FIG. 1H is an exemplary screen display that allows an operator to add a sub-account holder to an existing account that is enabled to use time-limited purchase codes for transactions;

FIG. 1I is an exemplary screen display that allows an operator to add funds to a sub-account in connection with a main account that is enabled to use time-limited purchase codes for transactions;

FIG. 2 is logical flowchart illustrating a method for generating a time-limited purchase code for known purchase amount based transactions using a PCD;

FIG. 3 is logical flowchart illustrating a method for generating a time-limited purchase code for fuel based transactions using a PCD;

FIG. 4 is a functional block diagram of an exemplary, non-limiting aspect of a PCD in the form of a wireless telephone for implementing methods and systems for generating a time-limited purchase code for transactions using the PCD; and

FIG. 5 is a functional block diagram of an exemplary, nonlimiting aspect of a general-purpose computer for implementing methods and systems for generating a time-limited purchase code for transactions using a PCD.

### DETAILED DESCRIPTION

The word “exemplary” is used herein to mean “serving as an example, instance, or illustration.” Any aspect described herein as “exemplary” is not necessarily to be construed as exclusive, preferred or advantageous over other aspects.

In this description, the term “application” may also include files having executable content, such as: object code, scripts, byte code, markup language files, and patches. In addition, an “application” referred to herein, may also include files that are not executable in nature, such as documents that may need to be opened or other data files that need to be accessed.

As used in this description, the terms “component,” “database,” “module,” “system,” “processing component” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer.

By way of illustration, both an application running on a computing device and the computing device may be a component. One or more components may reside within a process and/or thread of execution, and a component may be localized on one computer and/or distributed between two or more computers. In addition, these components may execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

In this description, the terms “central processing unit (“CPU”),” “digital signal processor (“DSP”),” and “chip” are used interchangeably. Moreover, a CPU, DSP, or a chip may be comprised of one or more distinct processing components generally referred to herein as “core(s).”

In this description, the term “portable computing device” (“PCD”) is used to describe any device operating on a limited capacity power supply, such as a battery and/or capacitor. Although battery operated PCDs have been in use for decades, technological advances in rechargeable batteries coupled with the advent of third generation (“3G”) and fourth generation (“4G”) wireless technology have enabled numerous PCDs with multiple capabilities. Therefore, a PCD may be a cellular telephone, a satellite telephone, a pager, a PDA, a smartphone, a navigation device, a smartbook or reader, a media player, a combination of the aforementioned devices, a laptop computer with a wireless connection, among others.

FIG. 1A is a functional block diagram illustrating an exemplary system 100 for generating a time-limited purchase code for transactions using a PCD. The system 100 may comprise a portable computing device 101 running a client side purchase code application/module 102, a point-of-sale (“POS”) terminal 115, a computer communications network 142, a purchase server 125, a funding account maintained at a funding account server 135 associated with the portable computing device 101, and a merchant bank 140 associated with the POS terminal 115. Each of these elements of the system 100 are coupled to the computer communications network 142 via communication links 103.

The communication links 103 illustrated in FIG. 1A may comprise wired or wireless communication links. Wireless communication links include, but are not limited to, radio-frequency (“RF”) links, such as, BLUETOOTH™ RF links, WIFI™ RF links, as well as infrared links, acoustic links, and other wireless mediums. The communications networks 142 may comprise a wide area network (“WAN”), a local area network (“LAN”), the Internet, a Public Switched Telephony Network (“PSTN”), or any combination thereof.

The communications network 142 may be established by broadcast RF transceiver towers (not illustrated). However, one of ordinary skill in the art recognizes that other types of communication devices besides broadcast RF transceiver towers are included within the scope of the system 100 for establishing the communications network 142. The exemplary communication network 142 of FIG. 1A may employ wireless communications towers (not shown) which couple to the antennas of the portable computing device (PCD) 101 and the POS terminal 115.

As noted previously, the PCD 101 may be running or executing a purchase code application/module 102. The PCD 101 may also have a location positioning system (LPS) unit 415 for ascertaining geographical coordinates of the PCD 101 as understood by one of ordinary skill in the art. The PCD 101 with its LPS unit 415 may receive and transmit signals including, location parameters, from satellites, including satellites that are part of the Global Positioning System (GPS), Galileo, GLONASS, NAVSTAR, GNSS, any system that uses satellites from a combination of these systems, or any satellite positioning system subsequently developed. The LPS unit 415 may also use other network information such as an Internet Protocol (“IP”) address, WiFi service set identifiers (SSIDs) from wireless local area networks (LANs), telecom signal identification, and/or triangulation from sources other than satellites collectively referred to as a Location Positioning System (“LPS”) in this disclosure.

As understood by one of ordinary skill in the art, however, the technology of all LPS systems is constantly being improved. New as yet unknown technologies for location determination and for determining location parameters of use with this system 100, may be used in connection with the mobile commerce authentication and authorization system of this disclosure, and are included in the meaning of “LPS” as described above.

To complete a purchase transaction, an operator of the PCD 101 may request a time-limited purchase code 110 using the purchase code module 102 running on the PCD 101. This request may include a purchase amount and the geographical coordinates determined by the LPS unit 415 within the PCD 101. The request may be transmitted over the communications link 103 and over the communications network 142 to the purchase server 125. The purchase server 125 may include a purchase code generation module 130.

Upon receiving the request for the purchase code, the purchase server 125 may store the geographical coordinates of the PCD 101 in memory for later/subsequent verification of a purchase transaction with the PCD 101. The purchase server 125 may verify that the purchase amount in the request does not exceed the amount of funds existing in a funding account server 135. If the purchase amount does not exceed the amount of funds existing in the funding account server 135, then the purchase server 125 may have the purchase code generation module 130 generate a time-limited purchase code 110.

The time-limited purchase code 110 may comprise alphanumeric text having a length between about two characters and about sixteen characters, and more preferably, between four and nine characters in length. The time-limited purchase code 110 usually comprises alphanumeric text which is randomly generated, cryptographically secure, and is usually not sequential in nature. According to one exemplary embodiment, the time limit restriction for “known” purchase amount based transactions may comprise a range between about five minutes and about fifteen minutes, and preferably at about ten minutes.

Meanwhile, timing for unknown-purchase-amount based transactions may be much longer. Unknown-purchase-amount based transactions will generally apply to those purchase transactions in which the exact purchase price of a product and/or service is indeterminate and not known by the consumer who is making the purchase. Authorization to pay from the purchase server 125 may be needed in advance of such transactions. Unknown-purchase-amount based transactions may include, but are not limited to, the following: purchasing gasoline from a gas station; paying for food from a salad bar by weight where the exact weight of the food to be selected is unknown; or driving a bucket of golf balls at a driving range. The time limit restriction for these unknown-purchase-amount transactions may be significantly longer such as between about twenty minutes to about forty minutes, and preferably about thirty minutes.

For unknown-purchase amount transactions, which will be described in connection with FIG. 3 listed below, a two step expiration may be used for the time-limited purchase code 110 in these transactions. If the purchase code 110 is not used at all, it may expire in about the a first “normal” ten minute window. However, if the purchase code 110 is conveyed through the pump (acting as the POS 115) then a new time-limited window starts to allow for the gas to be pumped/dispensed. This second, new time-limited window may be significantly longer than the first window, such as between about twenty minutes to about forty minutes, and preferably about thirty minutes.

The time-limited purchase code 110 may be transmitted from the purchase server 125 over the communications network 142 to the PCD 101. The PCD 101 may convey the purchase code 110 to the operator of the PCD 101 in one or more different ways. Ultimately, the purchase code 110 is designed to be received by the POS terminal 115 to complete a transaction.

The one or more different ways in which the purchase code 110 may be conveyed to the operator of the PCD 101 as well as to the POS terminal 115 may include, but are not limited to, displaying the purchase code 110 on a display device of the PCD 101 as alphanumeric text; conveying the purchase code 110 with synthesized voice generated by the PCD 101; displaying the purchase code 110 as a machine readable code such as a one-dimensional or two-dimensional barcode on a display device of the PCD 101; and/or relaying the purchase code 110 over eight wireless communications medium such as by near field communications (“NFC”) with an NFC equipped PCD 101, by audio signals, by infrared signals, and other various types of wireless proximity channels known to one of ordinary skill in the art.

If the purchase code 110 is displayed as alphanumeric text, then the operator the PCD 101 may enter a purchase code 110 into a keypad of a terminal which may be part of the POS terminal 115. If the purchase code 110 is displayed as a machine readable code such as a two-dimensional or one-dimensional barcode, then a barcode reader which may be part of the POS terminal 115, may scan the barcode in order to receive the purchase code 110.

The POS terminal 115 may comprise any type of machine used to complete purchase transactions. The POS terminal 115 may comprise a pin pad, a barcode reader, and/or an electronic cash register as understood by one of ordinary skill the art. In online environments, the POS terminal 115 may comprise a computer server which has software to mimic a POS terminal 115 as understood by one of ordinary skill the art. In other exemplary embodiments, the POS terminal 115 may also comprise software which runs on another PCD 101. That is, a merchant may have its own PCD 101 at the merchant location running POS terminal software for receiving the purchase code 110 from the operator of the PCD 101 who is attempting to complete a purchase.

Once the POS terminal 115 receives the purchase code 110 from the PCD 101, then it may pair the purchase code 110 with the geographical coordinates assigned to the POS terminal 115. The geographical coordinates assigned to the POS terminal 115 may be hard programmed into the POS terminal 115 by the merchant. Alternatively, the POS terminal 115 may only provide a mailing ZIP code associated with the physical location of the merchant. In other exemplary embodiment, the POS terminal 115 may also have unique identifier which is tracked by the purchase server 125. The purchase server 125 may store geographical coordinates associated with each unique identifier of a particular POS terminal.

The geocode information related to the POS terminal 115 in the purchase code 110 are retransmitted by the POS terminal 115 over the communications network 142 to the purchase server 125. The purchase server 125 may compare the geographical coordinates provided by the PCD 101 in the purchase code request with the geocode information related to the POS terminal 115 that has retransmitted the purchase code 110. The purchase server 125 may also compare the purchase code 110 transmitted from the POS terminal 115 with the purchase code 110 that was transmitted to the PCD 101.

If the geocode information matches as well as the purchase code matching, then the purchase server 125 will approve the purchase transaction. In some exemplary scenarios, the geographical coordinates of the PCD 101 may be unavailable for one or more various reasons. If the geographical comets of the PCD 101 are unavailable in/or fraud detection rules have determined that the PCD 101 is in an “odd” and/or suspicious location, the purchase server 125 may issue a verifier question instead of approving the transaction. Further details of this verifier question will be described below in connection with method 200A.

In the situation in which the geocode information and the purchase goods match, the purchase server 125 will issue an approval message that is transmitted over the three cases network 142 to the POS terminal 115. The POS terminal 115 may then complete the transaction and issue a receipt that may display a human readable version of the purchase code 110 that was used to complete the transaction. This receipt may be issued on paper or it may be issued electronically and transferred immediately to the PCD 101 via a wireless medium and or it may be transmitted as a text message or as an e-mail associated with the PCD 101.

The purchase server 125 may issue a debit to the funding account 135 server, such as using an automated clearinghouse (“ACH”) transaction as understood by one of ordinary skill the art. The purchase amount requested and associated with the purchase code 110 may then be transferred from the funding account 135 to the merchant's account server 140 which may be part of a financial institution, such as a bank. Similarly, the funding account server 135 may also be part of a financial institution, such as a bank. The funding account server 135 and the merchant account server 140 may be the same or different financial institutions as understood by one of ordinary skill the art.

FIG. 1B is an exemplary screen display 432B that list options for a PCD 101 which uses a time-limited purchase code 110 for transactions. This exemplary screen display 432B may be the first screen that an operator of the PCD 101 sees after logging into the purchase account maintained on the purchase server 125. The purchase code server 125 may require standard login credentials such as a username and password as understood by one of ordinary skill the art before this exemplary screen display 432B is displayed on the PCD 101. The purchase code server 125 may require a standard login or, as this screen in FIG. 1B displays no sensitive financial account information, may be more conveniently accessed using a simple PIN or with credentials saved on the phone according to user preference

The options for the exemplary screen display 432B may include, but are not limited to, generating a purchase code 215A, adding funds to the funding account 292, and managing account settings 294. While these options illustrated in FIG. 1B have been shown as selectable “buttons” within a graphical user interface (GUI), other types of displays and graphical presentation and manipulation of options are well within the scope of this disclosure as understood by one of ordinary skill the art. Further, the system 100 is not limited to visual displays which means that other ways of selecting these options are possible, such as using voice commands and speech recognition as understood by one of ordinary skill the art.

FIG. 1C is an exemplary screen display 432C that list options for account management with a PCD 101 which uses a time-limited purchase code for transactions. This list of options may be generated in response to the selection of the accounts settings button 294 of FIG. 1B. The account settings options for this exemplary screen display 432C may include, but are not limited to, adding funds 292, allocating funds 610, adding a bank account that will be associated with the purchase code account maintained on the purchase server 125, adding a user to the purchase code account 620, editing user restrictions 625, and changing the password for the purchase code account maintained that the purchase server 125.

FIG. 1D is an exemplary screen display 432D that allows an operator of a PCD 101 to enter a purchase amount prior to requesting a time-limited purchase code 110 for a transaction. Screen display 432D may be generated in response to the operator selecting the generate purchase code button 215A as illustrated in FIG. 1B. The screen display 432D may comprise an input field 211 for the operator to enter a purchase amount associated with a transaction. The screen display 432D may also comprise a request purchase code button 215B that may be selected by the operator of the PCD 101 after the purchase amount has been entered into the field 211.

FIG. 1E is an exemplary screen display 432E that conveys a time-limited purchase code 110 for a transaction. As described above, the time-limited purchase code 110 may comprise alphanumeric text and may have a predefined or predetermined number of digits. In the exemplary embodiment illustrated in FIG. 1E, the time-limited purchase code 110 has an exemplary length of nine digits. The exemplary screen display 432E may further include machine readable codes 288 that may comprise one-dimensional or two-dimensional barcodes as understood by one of ordinary skill in the art. These machine-readable codes 288 may be scanned with a barcode reader that is part of the POS terminal 115 described above. Exemplary screen display 432E may further include a countdown timer 237 that lists the remaining life left in the time-limited purchase code 110.

FIG. 1F is an exemplary screen display 432F that allows an operator to select specific sub-account holders for restricting use of an account that is enabled to use time-limited purchase codes 110 for transactions. Exemplary screen display 432F may be generated in response to an operator of the PCD 101 selecting the edit user restrictions button 625 of FIG. 1C. in this exemplary embodiment, a menu 635 is provided in which an operator of the PCD 101 may select a particular account user by name in which two modify restrictions associated with that account.

FIG. 1G is an exemplary screen display 432G that allows an operator of a PCD 101 to define specific restrictions for a sub-account holder corresponding to an account that is enabled to use time-limited purchase codes for transactions. This exemplary screen display 432G may be generated in response to the selected subaccount holder from menu 635 of FIG. 1F. A plurality of different restrictions 640 may be available to the main account holder for applying to the sub-account holders listed in the menu 635 of FIG. 1F. Some restrictions may include, but are not limited to, maximum purchase amount usually listed in some form of currency (i.e.—U.S. dollars and cents for U.S. based transactions); geographical restrictions such as a geographical radius relative to a specific address such as the home address of the main account user; and restrictions with respect to types and/or names of particular merchants at which the purchase code account may be used. Other restrictions are possible and are within the scope of this disclosure as understood by one of ordinary skill in the art.

As an example, one sub-account that may be created by the operator of the PCD is an account for a child of the operator where the sub-account is restricted to certain types of purchases (i.e.—groceries only, fuel only, etc.), purchase limits (i.e. $100 or less), and/or restricted to certain geographical restrictions such as a 10 mile radius around a certain location such as a home.

The intended recipients of the sub-accounts may receive a text and/or e-mail that would allow an intended recipient to open and to access the sub-accounts. The sub-account may reflect a balance that has been assigned to that sub-account by the principal operator of the main account.

FIG. 1H is an exemplary screen display 432H that allows an operator of a PCD 101 to add a sub-account holder to an existing account that is enabled to use time-limited purchase codes 110 for transactions. Exemplary screen display 432H may be generated in response to the add user button 620 being selected by an operator of a PCD 101 as illustrated in FIG. 1C. Exemplary screen display 432H may comprise various fields to receive input in order to identify a new subaccount holder. Such fields may include, but are not limited to, a user name of the subaccount holder; a mobile phone number associated with the subaccount holder; and an e-mail address associated with the new subaccount holder.

FIG. 1I is an exemplary screen display 432I that allows an operator of a PCD 101 to add funds to a sub-account in connection with a main account that is enabled to use time-limited purchase codes 110 for transactions. Exemplary screen display 432I may be generated in response to an operator of the PCD 101 selecting the allocate funds button 610 as illustrated in FIG. 1C. In this exemplary screen display 432I, an operator of the PCD 101 may select a subaccount user in which to assign certain financial institution/bank accounts to be a associated with the purchase code account maintained at the purchase server 125. In addition to associating specific financial institution accounts, the main account operator of the PCD 101 may also identify a specific amount of funds listed in currency (i.e.—in U.S. dollars and cents for U.S. based transactions).

FIG. 2 is logical flowchart illustrating a method 200A for generating a time-limited purchase code 110 for known purchase amount based transactions using a PCD 101. Block 205 is the first block of method 200A.

In block 205, the operator of the portable computing device 101 opens up the payment application module 102 running on the portable computing device 101. The operator of PCD 101 enters his or her login credentials in order to initiate a session with the purchase code server 125 which works with the payment application module 101 running on the PCD 101. As noted above in connection with FIGS. 1F-1I, the operator of the portable computing device 101 may establish sub-accounts that may have their own login credentials and which may have some restrictions associated with them. Once a session with the payment server 125 is authorized, the screen display 432B illustrated in FIG. 1B may be presented to the operator of the PCD 101.

Next, in step 210, the operator of the PCD 101 may enter the purchase amount 211 for the transaction into the PCD 101, such as illustrated in FIG. 1D described above. The purchase amount 211 for the transaction may be exactly what is due from the operator of the PCD 101 who is the customer of the transaction. Alternatively, before the items being purchased have been tallied by the merchant, the operator the PCD 101 may estimate a purchase amount 211 which exceeds the anticipated purchase amount.

Next, in block 215, the operator of the PCD 101 may request a purchase code 110 for the purchase amount 211 which was just entered into the PCD 101. This request may involve selecting an option or menu icon 215B displayed in the payment application module running on the portable computing device 101, such as illustrated in FIG. 1D. In this block 215, the PCD 101 may also send geographical coordinates that it may have determined from its LPS unit 415 within the PCD 101. These geographical coordinates may enhance the security of the transaction since the payment server 125 may match the geographical coordinates of the PCD 101 with the geographical coordinates of the POS transaction terminal 115 as will be described below.

Next, in decision block 220, the payment server 125 determines if the funding account maintained by the funding account server 135 associated with purchase code account has sufficient funds to cover the purchase amount 211 entered in block 210. The payment server 125 may be reviewing funds in a checking account maintained at the funding account server 135, however, other accounts are within the scope of this disclosure. For example, other accounts include, but are not limited to, credit card accounts, stored value accounts (i.e. gift card accounts), micro-funding accounts (i.e.—credit for thresholds of about $300 or less) and other similar funding accounts in a financial institution server 135.

If the inquiry to decision block 220 is negative, then the “No” branch is followed to decision block 225 in which the payment server may entertain another request for funds based on a smaller purchase amount to address a situation when funds are available but did not match the initial payment amount request. In this way, the operator of the PCD 101 may remove some items/services from the purchase transaction in order to match the purchase amount with the amount available funds in the funding account at the funding account server 135.

If the inquiry to decision block 225 is negative, then the “No” branch is followed to the RETURN block in which the process/method 200A ends and a message is displayed to the operator the PCD 101 that the system was unable to process the transaction for insufficient funds in the funding account maintained at the funding account server 135. If the inquiry to decision block 225 is positive, then the “Yes” branch is followed back to block 210 where the operator of the PCD 101 may enter in a new purchase amount that is less than the previous requested purchase amount.

If the inquiry to decision block 220 is positive meaning that there were sufficient funds in the funding account maintained at the funding account server 135 to cover the requested purchase amount, then the “Yes” branch is followed to block 235 in which the payment server 125 via the purchase code generation module 130 generates a one-time use, time-limited, purchase code 110. The single-use, time-limited purchase code 110 may comprise alphanumeric text having a length between about two characters and about sixteen characters, and more preferably, between four and nine characters in length.

The single-use, time-limited purchase could 110 usually comprises alphanumeric text which is randomly generated and is usually not sequential in nature. According to one exemplary embodiment, the time limit restriction for known purchase amount transactions may comprise a range between about five minutes and about fifteen minutes, and preferably at about ten minutes. Meanwhile, for unknown-purchase-amount based transactions such as purchasing gasoline from a gas station, the time limit restriction may be significantly longer such as between about twenty minutes to about forty minutes, and preferably about thirty minutes.

In block 235, the purchase code 110 is transmitted from the server to the PCD 101 and is conveyed to the operator of the PCD. This conveyance of the purchase code 110 in block 235 may be in the form of a human-readable visual display on the display device of the PCD 101, and/or a machine-readable version of the code 110 visible as a 1-D barcode or a 2-D barcode such as illustrated in FIG. 1E described above. The PCD 101 may also convey the purchase code 110 via speech synthesizing software that renders an audible version of the purchase code to the operator of the PCD. In some exemplary embodiments, the operator of the PCD 101 may not need to visibly see the purchase code 110 if it is to be transmitted wirelessly along a proximity channel between the PCD 101 and the POS terminal 115.

In block 245, the POS terminal 115 may receive the purchase code 110. The POS terminal 115 may receive the purchase code 110 in a variety of ways depending on the type and hardware of the POS terminal 115. In one exemplary embodiment, the operator of the PCD 101 may enter the purchase code 110 via pin pad into the POS terminal/transaction terminal 115. According to another exemplary embodiment, the POS terminal 115 may comprise a programmable display pin pad as understood by one of ordinary skill the art and which has a specific key for indicating the use of purchase code type payments. In other exemplary embodiments, the POS terminal 115 may use voice recognition software/hardware to receive the purchase code from the speech of an operator of the PCD 101 or from a voice synthesizer of the PCD 101. In another exemplary embodiment, the POS terminal 115 may comprise a level one pin pad in which the operator the PCD 101 may key-in a phrase to indicate a purchase code 110 is about to be entered. According to one exemplary embodiment, this key phrase entered into a pin pad may comprise the term “ALT#” or the characters “258#.”

Alternatively, the PCD may transmit the purchase code 110 to the POS terminal via a proximity channel that may include, but is not limited to, NFC, an RF transmission such as Bluetooth, an acoustic transmission, an I/R transmission, and or other proximity channels as understood by one of ordinary skill the art. In another exemplary embodiment, the POS transaction terminal 115 may comprise another PCD 101 operated by the merchant. The merchant may have a merchant application running on his PCD 101 which prompts the merchant to enter or receive the purchase code 110. According to another exemplary embodiment, the POS transaction terminal 115 may comprise an online system which is prompting the online customer with options for payment that would include receiving the purchase code 110.

Next in block 250A, the POS transaction terminal 115 sends the purchase code 110 back to the purchase server 125 over the communications network 142 along with its geographical coordinates. As noted previously, in alternative exemplary embodiments, the POS terminal 115 may transmit back a unique identifier to the payment server 125. The payment server 125 may maintain a table that associates the unique identifier of the POS terminal 115 with geographical coordinates listed in the table.

In block 255A, if the payment server 125 determines that geographical information for the PCD 101 was not available when the operator the PCD 101 transmitted its payment request, then the payment server 125 may prompt the operator the PCD 101 to enter a verifier code at this stage. The verifier code may comprise any type of security information that may be supplied by the operator of the PCD 101 in order to prevent fraudulent purchases. For example, the server in block 255 may prompt the operator the PCD 101 to enter at least one of a mailing zip code, a name of a relative, the last four digits of a social security number, digits corresponding to a birth date, captcha-type information displayed in special window for on-line purchases, or other similar security information known to one of ordinary skill the art.

The server receives the purchase code in decision block 260A and determines if the purchase code 110 and the timestamp for the purchase code 110 match the parameters associated with the request for the purchase code 110 received in block 215. Specifically, the payment server 125 determines if the purchase code 110 received matches the purchase code 110 that was issued based on the prior request in block 215. The payment server 125 also determines the length of time between the date stamp for the issuance of the purchase code 110 and the date stamp associated with the receipt of the payment code 110 at the POS terminal And the payment server 125 may also determine if there is a match between the geographical coordinates of the PCD 101 and the geographical coordinates for the POS terminal 115.

In decision block 260A, the payment server 125 may also execute one or more fraud control rules as understood by one of ordinary skill the art. These fraud control rules may be associated with the purchase amount 211 as well as the geographical location of the POS terminal 115. The fraud control rules may also be associated with spending limits that are assigned to the payment server 125 based on the financial service provider associated with the funding account at the funding account server 135.

If the inquiry to decision block 260A is negative, then the “NO” branch is followed to decision block 265A in which the operator the PCD 101 is given the opportunity to reenter/re-transmit the purchase code 110. If the purchase code 100 and has already been entered more than once and the code 110 did not match or failed decision block 265A, then the “NO” branch is followed to block 290A in which the transaction is terminated and a message is displayed on either or both of the POS terminal 115 in PCD 101 that the purchase was not approved. The method 200A may then end.

If the inquiry to decision block 260A is positive, then the “YES” branch is followed to block 270A in which the purchase server 125 sends a receipt to the POS transaction terminal 115. The receipt information may comprise the approved purchase code 110, the terminal ID for the POS terminal 115, the timestamp, and the purchase amount 211. In block 275A, the funding account at the funding server 135 associated with the operator the PCD 101 is then flagged for debit by the purchase amount approved with the purchase code 110.

Next, in block 280A, the purchase is completed and the transaction is saved in memory at the purchase server 125 for later batch settlement as understood by one of ordinary skill in the art. Subsequently, usually at the end of the business day generally in the evening hours, be completed transaction is settled between the purchase server 125, the funding account server 135, and the merchant account at the merchant account server 140.

FIG. 3 is logical flowchart illustrating a method 200B for generating a time-limited purchase code 110 for unknown-purchase-amount based transactions using a PCD 101. The logical flowchart and method 200B of FIG. 3 is very similar to the logical flowchart and method 200 day of FIG. 2. Similar reference characters for the various blocks in FIG. 3 are used to match reference characters of FIG. 2. Only the differences between FIGS. 2-3 will be described below.

As noted above, the time limit for the life of the purchase code 110 may be different, and hence longer for unknown-purchase-amount based transactions compared to known purchase amount based transactions. Specifically, for fuel based transactions such as purchasing gasoline from a gas station, the time limit restriction may be significantly longer such as between about twenty minutes to about forty minutes, and preferably about thirty minutes. While fuel based transactions will be described below, these fuel based transactions are equally applicable to all transactions involving unknown-purchase-amounts as described above.

Off the page marker block 240 is the first block of method 200B. Off the page marker block 240B indicates that all blocks 205-240 of FIG. 2 has been completed up to this stage of method 200B. Next, in block 250B, a fuel based POS terminal 115 says the purchase code 110 over the communications network 142 to the purchase code server 125. In addition to sending the purchase code 110 in this block 250B, the fuel based POS terminal 115 may send its unique identifier which may allow the purchase code server 125 to determine its geographical location. Further, the unique identifier associated with a fuel based POS terminal 115 may also be associated with one or more unique business rules that are to be applied for only fuel based transactions (and more generally, for unknown-purchase-amount based transactions). Further details of these unique business rules will be described below in connection with blocks 262 and 263.

Decision blocks 260B and 265B as well as block 290B function the same as their corresponding blocks and FIG. 2 of method 200A. If the inquiry to decision block 260B is positive, then the “YES” branch is followed to block 261 in which the purchase code server 125 sends a message that indicates the operator of the PCD 101 is authorized to dispense the fuel for the purchase amount that was specified earlier in block 210 of FIG. 2.

Next, at block 262, the off signal for the fuel pump is detected meaning that the operator of the PCD 101 has completed the dispensing of fuel. In decision block 263, the purchase code server 125 verifies that some amount of fuel was dispensed. If the inquiry to decision block 263 is negative meaning that the operator the PCD 101 never dispensed any fuel, then the “NO” branch is followed to block 270B which operates similarly to block 270A FIG. 2. If the inquiry to decision block 263 is positive meaning that the operator of the PCD 101 has dispensed some amount of fuel, then the “YES” is followed to block 264.

The money equivalent of the fuel dispensed is transmitted from the POS terminal 115 over the communications network 142 to the purchase code server 125. Next, in decision block 266, the purchase code server 125 determines if the money equivalent of the fuel dispensed is within a certain threshold relative to the purchase amount that was requested back in block 210. In some situations, the operator of the PCD 101 may have dispensed more fuel than corresponds with the purchase amount. In this decision block 266, the purchase code server 125 may follow one or more business rules that govern the threshold or range between the money equivalent of the fuel dispensed and the purchase amount that was requested by the operator of the PCD 101 back in block 210.

For example, one exemplary business rule may comprise a threshold of at least a 20% margin between the amount of fuel dispensed and the payment amount requested by the operator of the PCD 101 back in block 210 when the purchase code request was made. This means that for a $40 purchase code request, the purchase code server 125 would approve those transactions in which the money equivalent for the amount of fuel dispensed is less than or equal to about $8.00 (which is 20% of US$40).

If the inquiry to decision block 266 is negative meaning that the money equivalent of the actual fuel dispensed exceeds the threshold assigned by the purchase code server 125 (i.e.—exceeds the 20% example provided above which would be more than $8.00, like $8.01), then the “NO” branch is followed to the RETURN block in which the purchase is rejected by the purchase code server 125. The process 200B may then return back to block 210 of FIG. 2 in which the operator of the PCD 101 may now enter the exact amount of the money equivalent for the fuel dispensed.

If the inquiry to decision block 266 is positive meaning that the money equivalent of the actual fuel dispensed did not exceed the threshold assigned by the purchase code server 125, then the “YES” branch is followed to block 270B. These blocks 270B, 275B, 280A, and 285A all function similarly to the corresponding blocks in FIG. 2 and will not be described here.

A few important aspects of the system 100 may include the timing between certain blocks/stages in FIGS. 2-3. Specifically, the time between block 215 in which a purchase code is requested by the operator of a PCD 101 and the time in which the purchase code is conveyed to the operator of the PCD 101 in block 235 should take only about 2.0 to about 3.0 seconds. Similarly, the time between the purchase code 110 being conveyed in block 235 and block 270A in which the purchase code server 125 sends a receipt to the POS terminal 115 should only take between about 1.0 to about 2.0 seconds. Likewise, the time between the fuel dispensed shut off signal in block 262 to the purchase code server sending a receipt to the POS terminal 115 in block 270B should only take between about 1.0 to about 2.0 seconds. In this way, both the merchant and operator of the PCD 101 will benefit from an electronic transaction that may operate as fast as exchanging actual currency.

FIG. 4 is a functional block diagram of an exemplary, non-limiting aspect of a PCD 101 in the form of a wireless telephone for implementing methods and systems for generating a time-limited purchase code 110 for transactions using the PCD 101. The PCD 101 of FIG. 4 corresponds to the PCD 101 of FIG. 1A.

As shown, the mobile telephone 101 includes an on-chip system 422 that includes a digital signal processor or a central processing unit 424 and an analog signal processor 426 that are coupled together. As illustrated in FIG. 4, a display controller 428 and a touchscreen controller 430 are coupled to the digital signal processor 424. A touchscreen display 432 external to the on-chip system 422 is coupled to the display controller 428 and the touchscreen controller 430.

FIG. 4 further illustrates a video encoder 434, e.g., a phase-alternating line (“PAL”) encoder, a sequential couleur avec memoire (“SECAM”) encoder, a national television system(s) committee (“NTSC”) encoder or any other video encoder, is coupled to the digital signal processor 424. Further, a video amplifier 436 is coupled to the video encoder 434 and the touchscreen display 432. A video port 438 is coupled to the video amplifier 436. As depicted in FIG. 4, a universal serial bus (“USB”) controller 440 is coupled to the digital signal processor 424. Also, a USB port 442 is coupled to the USB controller 440. A memory 412 and a subscriber identity module (“SIM”) card 446 may also be coupled to the digital signal processor 424.

Further, as shown in FIG. 4, a digital camera 435 may be coupled to the digital signal processor 424. In an exemplary aspect, the digital camera 435 is a charge-coupled device (“CCD”) camera or a complementary metal-oxide semiconductor (“CMOS”) camera.

As further illustrated in FIG. 4, a stereo audio CODEC 450 may be coupled to the analog signal processor 426. Moreover, an audio amplifier 452 may be coupled to the stereo audio CODEC 450. In an exemplary aspect, a first stereo speaker 454 and a second stereo speaker 456 are coupled to the audio amplifier 452. FIG. 4 shows that a microphone amplifier 458 may be also coupled to the stereo audio CODEC 450. Additionally, a microphone 460 may be coupled to the microphone amplifier 458. In a particular aspect, a frequency modulation (“FM”) radio tuner 462 may be coupled to the stereo audio CODEC 450. Also, a FM antenna 464 is coupled to the FM radio tuner 462. Further, stereo headphones 466 may be coupled to the stereo audio CODEC 450.

FIG. 4 further illustrates a radio frequency (“RF”) transceiver 468 that may be coupled to the analog signal processor 426. An RF switch 470 may be coupled to the RF transceiver 468 and an RF antenna 472. The RF transceiver 468 may communicate with conventional communications networks 142.

As shown in FIG. 4, a keypad 474 may be coupled to the analog signal processor 426. Also, a mono headset with a microphone 476 may be coupled to the analog signal processor 426. Further, a vibrator device 478 may be coupled to the analog signal processor 426. FIG. 4 also shows that a power supply 480 may be coupled to the on-chip system 422. In a particular aspect, the power supply 480 is a direct current (“DC”) power supply that provides power to the various components of the mobile telephone 101 that require power. Further, in a particular aspect, the power supply is a rechargeable DC battery or a DC power supply that is derived from an alternating current (“AC”) to DC transformer that is connected to an AC power source.

FIG. 4 also shows that the mobile telephone 101 may include a global positioning system (“LPS”) module 415. The LPS module 115 may comprise hardware and/or software. The LPS module 415 may be coupled to the processor 424. Also coupled to the processor 424 may be a compass 420, an accelerometer 425, and the purchase code module 102 described above.

As depicted in FIG. 4, the touchscreen display 432, the video port 438, the USB port 442, the camera 485, the first stereo speaker 454, the second stereo speaker 456, the microphone 460, the FM antenna 464, the stereo headphones 466, the RF switch 470, the RF antenna 472, the keypad 474, the mono headset 476, the vibrator 478, and the power supply 480 are external to the on-chip system 422.

In a particular aspect, one or more of the method steps described above (such as illustrated in FIGS. 2-3) may be stored in the memory 412 as computer program instructions. These instructions may be executed by the digital signal processor or central processing unit 424, the analog signal processor 426, or another processor, to perform the methods 200A-200B described herein. Further, the processors, 424, 426, the memory 812, the instructions stored therein, or a combination thereof may serve as a means for performing one or more of the method steps described herein.

FIG. 5 is a functional block diagram of an exemplary, nonlimiting aspect of a general-purpose computer for implementing a method 200 and system 100 for generating a time-limited purchase code 100 for transactions using a PCD 101. The exemplary operating environment for the system 100 includes a general-purpose computing device in the form of this conventional computer 115, 125, 135, 140. This means that POS terminal 115, the purchase code server 125, the funding account server 135, and the merchant account server 140 may all comprise general purpose computers.

Generally, a computer 115 includes a processing unit 521, a system memory 522, and a system bus 523 that couples various system components including the system memory 522 to the processing unit 521. The system bus 523 may be any of several types of bus structures including a memory bus or memory controller, a peripheral bus, and a local bus using any of a variety of bus architectures. The system memory includes a read-only memory (ROM) 524 and a random access memory (RAM) 525. A basic input/output system (BIOS) 526, containing the basic routines that help to transfer information between elements within computer 115, such as during start-up, is stored in ROM 524.

The computer 110 can include a hard disk drive 527A for reading from and writing to a hard disk, not shown, a magnetic disk drive 528 for reading from or writing to a removable memory device 529, and an optical disk drive 530 for reading from or writing to a removable optical disk 531 such as a CD-ROM or other optical media. Hard disk drive 527A, memory device drive 528, and optical disk drive 530 are connected to system bus 523 by a hard disk drive interface 532, a removable memory interface 533, and an optical disk drive interface 534, respectively.

Although the exemplary environment described herein employs hard disk 527A, removable memory 529, such as a USB drive and/or flash memory, and removable optical disk 531, it should be appreciated by those skilled in the art that other types of computer readable media which can store data that is accessible by a computer, such as magnetic cassettes, flash memory cards, digital video disks, Bernoulli cartridges, RAMs, ROMs, and the like, may also be used in the exemplary operating environment without departing from the scope of the invention. Such uses of other forms of computer readable media besides the hardware illustrated will be used in internet connected devices such as in cellular phones 101 and/or personal digital assistants (PDAs) 101.

The drives and their associated computer readable media illustrated in FIG. 5 provide nonvolatile storage of computer-executable instructions, data structures, program modules, and other data for computer 110 or client device 101. A number of program modules may be stored on hard disk 527, removable memory 529, optical disk 531, ROM 524, or RAM 525, including, but not limited to, an operating system 535, an purchase code module 130, and purchase account management modules 133.

Program modules include routines, sub-routines, programs, objects, components, data structures, etc., which perform particular tasks or implement particular abstract data types. Aspects of the present invention may be implemented in the form of a downloadable, purchase code module 102 which is executed by a mobile device 101 or computer 115 in order to provide single use, time-limited purchase codes 110 for completing transactions.

A user may enter commands and information into computer 115 through input devices, such as a keyboard 540 and a pointing device 542. Pointing devices may include a mouse, a trackball, and an electronic pen that can be used in conjunction with an electronic tablet. Other input devices (not shown) may include a microphone, joystick, game pad, satellite dish, scanner, or the like.

These and other input devices are often connected to processing unit 521 through a serial port interface 546 that is coupled to the system bus 523, but may be connected by other interfaces, such as a parallel port, game port, a universal serial bus (USB), or the like.

The display 547 may also be connected to system bus 523 via an interface, such as a video adapter 548. As noted above, the display 547 can comprise any type of display devices such as a liquid crystal display (LCD), a plasma display, an organic light-emitting diode (OLED) display, and a cathode ray tube (CRT) display.

The camera 485 may also be connected to system bus 523 via an interface, such as an adapter 570. As noted previously, the camera 485 can comprise a video camera such as a webcam. The camera 495 can be a CCD (charge-coupled device) camera or a CMOS (complementary metal-oxide-semiconductor) camera. In addition to the monitor 547 and camera 495, a computer 115 may include other peripheral output devices (not shown), such as speakers and printers.

The computer 115 may operate in a networked environment using logical connections to one or more remote computers, such as funding account server 135. The funding account server 135 may be another personal computer, a server, a mobile phone 101, a router, a network PC, a peer device, or other common network node. While the remote computer 135 typically includes many or all of the elements described above relative to the client device 101, only a memory storage device 527B has been illustrated in FIG. 5.

The logical connections depicted in FIG. 5 include a local area network (LAN) 142A and a wide area network (WAN) 142B. Such networking environments are commonplace in offices, enterprise-wide computer networks, intranets, and the Internet.

When used in a LAN networking environment, the computer 115 is often connected to the local area network 142 through a network interface or adapter 553. When used in a WAN networking environment, the computer 115 typically includes a modem 554 or other means for establishing communications over WAN 142B, such as the Internet. Modem 554, which may be internal or external, is connected to system bus 523 via serial port interface 546. In a networked environment, program modules depicted relative to the server 125, or portions thereof, may be stored in the remote memory storage device 527B. It will be appreciated that the network connections shown are exemplary and other means of establishing a communications link 103 between the computers 115 and mobile phones 101 may be used.

Moreover, those skilled in the art will appreciate that the present invention may be implemented in other computer system configurations, including hand-held devices, multiprocessor systems, microprocessor based or programmable consumer electronics, network personal computers, minicomputers, mainframe computers, and the like. The invention may also be practiced in distributed computing environments, where tasks are performed by remote processing devices that are linked through a communications network. In a distributed computing environment, program modules may be located in both local and remote memory storage devices.

Certain steps in the processes or process flows described in this specification naturally precede others for the invention to function as described. However, the invention is not limited to the order of the steps described if such order or sequence does not alter the functionality of the invention. That is, it is recognized that some steps may performed before, after, or parallel (substantially simultaneously with) other steps without departing from the scope and spirit of the invention. In some instances, certain steps may be omitted or not performed without departing from the invention. Further, words such as “thereafter”, “then”, “next”, “subsequently”, etc. are not intended to limit the order of the steps. These words are simply used to guide the reader through the description of the exemplary method.

Additionally, one of ordinary skill in programming is able to write computer code or identify appropriate hardware and/or circuits to implement the disclosed invention without difficulty based on the flow charts and associated description in this specification, for example. Therefore, disclosure of a particular set of program code instructions or detailed hardware devices is not considered necessary for an adequate understanding of how to make and use the invention. The inventive functionality of the claimed computer implemented processes is explained in more detail in the above description and in conjunction with the drawings, which may illustrate various process flows.

In one or more exemplary aspects, the functions described may be implemented in hardware, software, firmware, or any combination thereof. If implemented in software, the functions may be stored on or transmitted as one or more instructions or code on a computer-readable medium. Computer-readable media include both computer storage media and communication media including any medium that facilitates transfer of a computer program from one place to another. A storage media may be any available media that may be accessed by a computer. By way of example, and not limitation, such computer-readable media may comprise RAM, ROM, EEPROM, CD-ROM or other optical disk storage, magnetic disk storage or other magnetic storage devices, or any other medium that may be used to carry or store desired program code in the form of instructions or data structures and that may be accessed by a computer.

Also, any connection is properly termed a computer-readable medium. For example, if the software is transmitted from a website, server, or other remote source using a coaxial cable, fiber optic cable, twisted pair, digital subscriber line (“DSL”), or wireless technologies such as infrared, radio, and microwave, then the coaxial cable, fiber optic cable, twisted pair, DSL, or wireless technologies such as infrared, radio, and microwave are included in the definition of medium.

Disk and disc, as used herein, includes compact disc (“CD”), laser disc, optical disc, digital versatile disc (“DVD”), floppy disk and blu-ray disc where disks usually reproduce data magnetically, while discs reproduce data optically with lasers. Combinations of the above should also be included within the scope of computer-readable media.

Therefore, although selected aspects have been illustrated and described in detail, it will be understood that various substitutions and alterations may be made therein without departing from the spirit and scope of the present invention, as defined by the following claims.

What is claimed is:

1. A method for completing a transaction with a portable computing device, the method comprising:
receiving credentials from a communications network for accessing a purchase code account;
receiving a request for a purchase code from a communications network, the request further comprising a purchase amount and first location information;
determining if a funding account has sufficient funds to cover the purchase amount;
if the funding account has sufficient funds to cover the purchase amount, then generating a first instance of a single-use time limited purchase code for completing the transaction;
transmitting the first instance of the single-use time limited purchase code over the communications network;
receiving a transaction amount, a second instance of the single-use time limited purchase code, and second location information from the communications network; and
determining if second instance of the single-use time limited purchase code matches the first instance of the single-use time limited purchase code.

2. The method of claim 1, further comprising determining if the first location information matches the second location information.

3. The method of claim 2, further comprising determining if the transaction amount is less than or equal to the purchase amount.

4. The method of claim 3, further comprising if instances of the purchase codes and location information match and if the transaction amount is less than or equal to the purchase amount, then generating a message approving the transaction.

5. The method of claim 1, wherein the first single-use time limited purchase code comprises alphanumeric text.

6. The method of claim 5, wherein the first single-use time limited purchase code has a length between about two characters and about sixteen characters.

7. The method of claim 6, wherein the first single-use time limited purchase code is randomly generated and is non-sequential.

8. The method of claim 1, further comprising determining if the transaction relates to an unknown-purchase-amount.

9. The method of claim 8, further comprising if the transaction relates to an unknown-purchase amount, then setting a time limit for the single-use time limited purchase code to be between about twenty minutes to about forty minutes.

10. The method of claim 1, wherein the portable computing device comprises at least one of a mobile telephone, a personal digital assistant, a pager, a smartphone, a navigation device, and a hand-held computer with a wireless connection or link.

11. A method for completing a transaction with a portable computing device, the method comprising:
receiving credentials from a communications network for accessing a purchase code account;
receiving a request for a purchase code from a communications network, the request further comprising a purchase amount and first location information;
determining if a funding account has sufficient funds to cover the purchase amount;
if the funding account has sufficient funds to cover the purchase amount, then generating a first instance of a single-use time limited purchase code for completing the transaction; and
transmitting the first instance of the single-use time limited purchase code over the communications network;
receiving a transaction amount, a second instance of the single-use time limited purchase code, and second location information from the communications network; and
determining if the transaction relates to an unknown-purchase-amount.

12. The method of claim 11, further comprising determining if second instance of the single-use time limited purchase code matches the first instance of the single-use time limited purchase code.

13. The method of claim 12, further comprising determining if the first location information matches the second location information.

14. The method of claim 13, further comprising determining if the transaction amount is less than or equal to the purchase amount.

15. The method of claim 14, further comprising if instances of the purchase codes and location information match and if the transaction amount is less than or equal to the purchase amount, then generating a message approving the transaction.

16. The method of claim 11, further comprising if the transaction relates to an unknown-purchase-amount, then setting a time limit for the single-use time limited purchase code to be between about twenty minutes to about forty minutes.

17. A system for completing a transaction with a portable computing device, the system comprising
means for receiving a request for a purchase code from a communications network, the request further comprising a purchase amount and first location information;
means for determining if a funding account has sufficient funds to cover the purchase amount;
means for generating a first instance of a single-use time limited purchase code for completing the transaction if the funding account has sufficient funds to cover the purchase amount;
means for transmitting the first instance of the first single-use time limited purchase code over the communications network;
means for receiving a transaction amount, a second instance of the single-use time limited purchase code, and second location information from the communications network; and
means for determining if the second instance of the time limited purchase code matches the first instance of the single-use time limited purchase code.

18. The system of claim 19, further comprising means for determining if the first location information matches the second location information.

19. The system of claim 18, further comprising means for determining if the transaction amount is less than or equal to the purchase amount.

20. The system of claim 19, further comprising means for generating a message approving the transaction instances of the purchase codes and location information match and if the transaction amount is less than or equal to the purchase amount.
